(19) United States
(12) Patent Application Publication
(10) Pub. No.: US 2019/0199521 A1
(43) Pub. Date: Jun. 27, 2019

(54) METHOD AND APPARATUS FOR SECURE ACCESS TO A SENSOR OR DEVICE NETWORK

(71) Applicants: Ian L. Sayers, South Shields (GB); Paul J. Long, San Francisco, CA (US)

(72) Inventors: Ian L. Sayers, South Shields (GB); Paul J. Long, San Francisco, CA (US)

(21) Appl. No.: 15/660,621

(22) Filed: Jul. 26, 2017

Related U.S. Application Data
(60) Provisional application No. 62/373,637, filed on Aug. 11, 2016.

(51) Int. Cl. H04L 9/08; H04L 29/08; H04L 9/14; H04L 29/06

(52) U.S. Cl. CPC H04L 9/0819; H04L 67/12; H04L 63/20; H04L 9/14; H04L 9/085; H04L 9/0894

(57) ABSTRACT

One embodiment of this invention describes a method and apparatus for the secure identification and validation of devices on a network using a low complexity method. In addition, any data transmitted between the devices to/from the network is secured by means of encryption techniques. The method as described herein is intended to protect and secure devices that might need to access a secured sensor or device type of network, for example an Internet of Things (IOT) network. However it could easily be adapted to other types of networks to provide comparable levels of security and protection.

A further understanding of the nature and the advantages of particular embodiments disclosed herein may be realized by referencing the remaining portions of the specification and the attached drawings.

### CROSS REFERENCE TO RELATED PATENT APPLICATIONS

This application claims priority to U.S. Provisional Patent Application Ser. No. 62/373,637 filed on Aug. 11, 2016, entitled “METHOD AND APPARATUS FOR SECURING A SENSOR OR DEVICE”, which is hereby fully incorporated by reference.

### SUMMARY

One embodiment of this invention describes a method and apparatus for the secure identification and validation of devices on a network using a low complexity method. In addition any data transmitted between the devices to/from the network is secured by means of encryption techniques. The method as described herein is intended to protect and secure devices that might need to access a secured sensor or device type of network, for example an Internet of Things (IOT) network. However it could easily be adapted to other types of networks to provide comparable levels of security and protection.

A further understanding of the nature and the advantages of particular embodiments disclosed herein may be realized by reference to the remaining portions of the specification and the attached drawings.

### BACKGROUND TO INVENTION

One embodiment of this invention describes a method and apparatus for the secure identification and validation of devices (e.g. Smartphones, Digital Computers, Access Nodes, Routers, Switches, HEMS, Satellites, and Smartgrids) on a network using a low complexity method. In addition, as part of this invention, any data transmitted to/from the devices to sensor/device type of network is secured by means of encryption techniques. Such a sensor/device type of network might be found in an Internet of Things (IOT) architecture.

As the all-pervasive Internet begins to adopt inter-communications between low complexity devices, there is a critical need to protect these devices from the types of security breaches found in their more complex cousins. In addition it is equally important to prevent the devices used to access these networks from infecting the network with malicious software or themselves being infected by unprotected sensors/devices, which would result in hackers to steal data. The security of the low complexity devices, e.g. Internet of Things (IOT) sensors or devices, is paramount in gaining the confidence of the end users and thereby the wide acceptance of such sensors or devices in a world now familiar with credit card hacks, personal data theft, and compromised email servers. The current set of available security solutions are predicated on communications between complex and powerful devices with substantial processing capabilities and almost limitless power. A majority of these contemporary solutions use convoluted encryption or validation schemes that necessitate the sending of large amounts of data between the devices in order to provide the desired level of protection. However these convoluted security schemes also, in general, require large processing engines (e.g. Intel CPUs), large power supplies and high bandwidth connections. As a consequence if they were to be implemented in low complexity sensor/devices to provide security, it would completely negate any benefits to be gained by such sensor/devices and seriously curtail their rapid introduction to the market. This is particularly true in the case of devices accessing the low complexity sensor/device networks e.g. IOT. More capable processing devices need to interwork with the IOT networks and not overwhelm the low complexity sensors/devices processing capabilities, while at the same time maintaining an adequate level of security. There are many cases of a secure network being compromised by inadequate access protection to the network.

It is an important key characteristic of the low complexity sensors/devices that they have very little processing power (i.e. low performance CPUs) and in some cases may have no processing capability at all. Added to this limitation is the likelihood that these sensors/devices will also have very limited power available, either from a small battery or in some cases via the use of energy harvesting techniques. Furthermore the low complexity sensor/device family usually only perform one or perhaps a few dedicated tasks and cannot be used to run other applications. It would be impossible to burden such low power and restricted sensors/devices with communication tasks that are typically performed by modern sophisticated and processing intensive devices with which they need to communicate.

There are a number of encryption and validation schemes that are currently used by the mobile and fixed network community. Perhaps the best and most studied mobile security scheme is that used by GSM networks [1], in development since 1989. The GSM network security relies on the exchange of multiple pieces of authentication data transmitted over the radio interface and sourced from a Subscriber Identity Module (SIM) embedded in the Mobile Station (MS) (e.g. Smartphone). There are multiple layer-3 messages required to authenticate the Mobile User, ignoring the underlying protocol to transfer those messages to and from the fixed radio network. The use of multiple messages to validate/authenticate a user is acceptable when failure to do so might cost the network operator considerable revenue due fraudulent accesses. Almost as a by-product of the authentication process, a shared encryption key is generated independently in the MS and network that allows the encryption of data sent on the radio interface. This radio interface encryption protects the mobile user from eavesdropping and secures the transmitted data. Using multiple messages to establish the validity of the user and generate an encryption key is acceptable when the processing capabilities of the mobile device and the power source available (i.e. large rechargeable battery) are also required to perform other tasks required of a modern Smartphone, this is in complete contrast to low complexity devices. The detailed protocols, procedures, and methods used by GSM based networks are proprietary and unique to the network; they are also very hard to incorporate into low complexity devices. Although the overall methods used in GSM networks are generally accepted as “good practice” for securing a mobile network.

More recently (circa 2001) [2] methods have been devised for breaking the security of a GSM network and thereby hacking into voice and data calls. One particular method relies on sniffing thousands of packets on the radio interface and deriving the original key used to encrypt the packets thereby making future packets easily readable. There are straightforward fixes to deal with these breaches but even the most secure network can eventually be compromised if the volume of encrypted data is sufficiently large.

As can be seen by anyone skilled in the art, the use of a heavyweight protocol like that used in GSM, although secure, would require considerable CPU processing power in the device as well as significant electrical power neither of which would be available in a low complexity sensor/device as addressed in this patent.

An alternative security scheme nominally directed towards low complexity devices is used by networks such as the Low Power Wide Area Network LoRaWAN™ [3] promoted by the LoRa Alliance. However the scheme chosen by the LoRa Alliance relies on a set of pre-stored keys in the end nodes and the use of AES-128 encryption. Although each end device has unique keys in order to operate, that key must be shared either over the air with the network to which it attaches or via personalization at production time. LoRa relies on mutual authentication between end devices by exchanging multiple messages in order to verify keys. As the key is potentially sent over the radio interface it is possible that it might be captured by a man in the middle attack and used to hack the node from which it was sent or it could be captured by the network to which it is sent if that network itself is not secure. Alternatively it might be possible to duplicate the node and produce multiple false inputs to a database thereby destroying the integrity of any data that has been collected. The scheme chosen by the LoRa Alliance appears to be quite vulnerable to attack [4] and easily compromised. Further the data exchanges uses JavaScript Object Notation (JSON) data encoding which might provide opportunities for hackers to break even the AES-128 encryption as the data stream will be very consistent from packet to packet, especially if the low complexity sensor/device is a simple temperature sensor or fuel level indicator. Added to this weak security the sensor/device is required to generate quite a substantial amount of “unnecessary” data that has to be transmitted on the radio interface necessitating the use of even more energy. The fact that the over the air encryption scheme requires multiple messages to establish authenticity and start the encryption process could reduce the battery life of a low complexity sensor/device. Furthermore the sensor/device has to support IP type addressing including the required JSON data encoding which inflates the size of the data packet that has to be sent on the radio interface once again requiring evermore energy.

Although there are many well-known network protocols such as SSH, SHA, SSL etc. that might be usable by a low complexity sensor/device network, these protocols are also vulnerable to attack as has been shown by numerous research articles [5, 6, and 7]. Even though these protocols are well known and understood, they unfortunately present very heavy processing requirements to the underlying hardware, a requirement that is not tenable when applied to a low complexity sensor/device.

In order to provide the level of security demanded by the end users and the network operator this patent presents a unique invention that addresses the dual problems of security complexity and power requirements. It is assumed that a low complexity sensor/device only has a small volume of data to send during each transmission interval. The NSA approved SIMON and SPECK families of lightweight block ciphers [8] can securely encode 128-bits of data using the minimum of processing resources while providing the same level of security as the AES-128/256 schemes [8]. It is possible to perform the SIMON and SPECK encryption/decryption in either hardware or software further reducing the design restrictions on the target sensor/device. The SIMON/SPECK scheme can also be used by any device to permit access to low complexity sensor/device networks.

The method outlined in this invention is able to provide devices with random keys that can be used to securely access the sensor/device network. Each device is always provided a unique set of keys, the key set is never duplicated. As an additional safeguard the pre-shared keys can be reformed each time a key is used if the device has the ability to dynamically change memory and is able to receive transmissions. This feature is also unique to the invention and provides an extra level of security.

A further understanding of the nature and the advantages of particular embodiments disclosed herein may be realized by reference to the remaining portions of the patent description and the attached drawings.

### BRIEF DESCRIPTION OF THE DRAWINGS

One embodiment of this invention and its advantages may be described with reference to the associated figures:

FIG. 1 (Prior art) Example of a Single Use Key security system.

FIG. 2 Illustrates the overall System Architecture showing the network architecture and all nodes associated with one embodiment of this invention.

FIG. 3 Typical message flow for a reporting type sensor.

FIG. 4 Typical message flow for a controller type sensor.

FIG. 5 Illustrative methods for authentication/validation and decryption using a split message flow.

FIG. 6. System architecture and typical message flow for initial registration of a device on the security system

FIG. 7. Illustrative method for authentication/validation and decryption between a device and a private site.

### REFERENCES

1. http://www.uky.edu/˜jclark/mas355/GSM.PDF
2. http://www.rtl-sdr.com/hacking-gsm-signals-with-an-rtl-sdr-and-topguw/
3. https://www.lora-alliance.org/What-Is-LoRa/Technology
4. Robert Miller, MWR Labs Whitepaper LoRa Security Building a Secure LoRa Solution, 22 Mar. 2016. https://labs.mwrinfosecurity.com/publications/lo/
5. https://www.androidheadlines.com/2017/02/google-security-crew-finds-a-hole-in-sha-1-encryption.html.
6. http://www.spiegel.de/international/germany/inside-the-nsa-s-war-on-internet-security-a-1010361.html
7. http://www.darkreading.com/attacks-breaches/ssl-drowns-in-yet-another-serious-security-flaw/d/d-id/1324521.
8. Beaulieu et al., “The SIMON and SPECK families of lightweight block ciphers”, National Security Agency, 19 Jun. 2013. https://eprint.iacr.org/2013/404.pdf
9. Bardis et al., True Random Number Generation Based on Environmental Noise Measurements for Military Applications, ISPRA'09 Proceedings of the 8th WSEAS International Conference on SIGNAL PROCESSING, ROBOTICS and AUTOMATION, pp68-73, Feb. 21-23, 2009, ISBN: 978-960-474-054-3. www.wseas.us/e-library/conferences/2009/cambridge/ISPRA/ISPRA09.pdf
10. Atmel™ 8-bit AVR Microcontroller ATmega328PB complete datasheet, Atmel-42397C-8-bit AVR-ATmega328PB_Datasheet_Complete-10/2015. http://ww1.microchip.com/downloads/en/DeviceDoc/Atmel-42397-8-bit-AVR-Microcontroller-ATmega328PB_Datasheet.pdf

### DETAILED DESCRIPTION OF EMBODIMENTS

One embodiment of this invention describes a method and apparatus for secure identification and authentication of devices on a network. The network may also encrypt the transmission of data between devices and the remote sensors/devices on a network. In the network described herein the remote sensors/devices typically send and receive data infrequently from/to said devices. Typically the data sent by the sensor/device typically contains limited bytes of information. This type of information flow might be found in an Internet of Things (IOT) network architecture, for example, Smart Grid Home Area Networks (HAN), Smart Grid Home Energy Management System (HEMS), Smart Grid Enterprise Networks, Smart Home Networks, Medical patient sensor systems, Automotive networks, and Health/Biometric sensor systems. However this should not restrict the applicability of any potential embodiment of this invention as described in this patent.

A further embodiment of this invention describes a method and apparatus for secure identification and authentication of two types of devices: UNKNOWN DEVICES (UD) 620 which are not registered or associated with the network prior to their first access to said network; or REGISTERED DEVICES (RD) 728 which are known to the network. The UD 620 and RD 728 might be, for example, Smartphones, Digital Computers, Access Nodes, Routers, Switches, HEMS, Satellites, and Smartgrids etc. The network may also encrypt the transmission of data between UD 620 and RD 728. In the network described herein the UD 620 or RD 728 typically exchange data randomly but frequently. The data sent by the UD 620 or RD 728 typically contains large volumes of information. This type of information flow might be found in an Enterprise/Private network architecture, for example, email servers, cloud servers such as SaaS (Software as a System), e-commerce servers, financial services, social networks, intranets, extranets, and other database or applications servers. However this should not restrict the applicability of any potential embodiment of this invention as described in this patent.

The methods described in one embodiment of this invention are capable of supporting billions of UD 620 or RD 728 in an efficient and cost effective manner. As IOT and similar sensor/device networks become more pervasive the need to reliably verify and log the identity of sensors/devices and UD 620 or RD 728, as well as to securely transport the data they carry from the source to destination becomes paramount. Not only is it important to securely transport the data such that the information remains unaltered by 3^{rd} parties, the network, sensor/device, and UD 620 or RD 728 need to authenticate each other to prevent interception of the data by 3^{rd} parties. One embodiment of this invention presents such a method that can be used to protect networks efficiently and cost-effectively so that all network types can be protected.

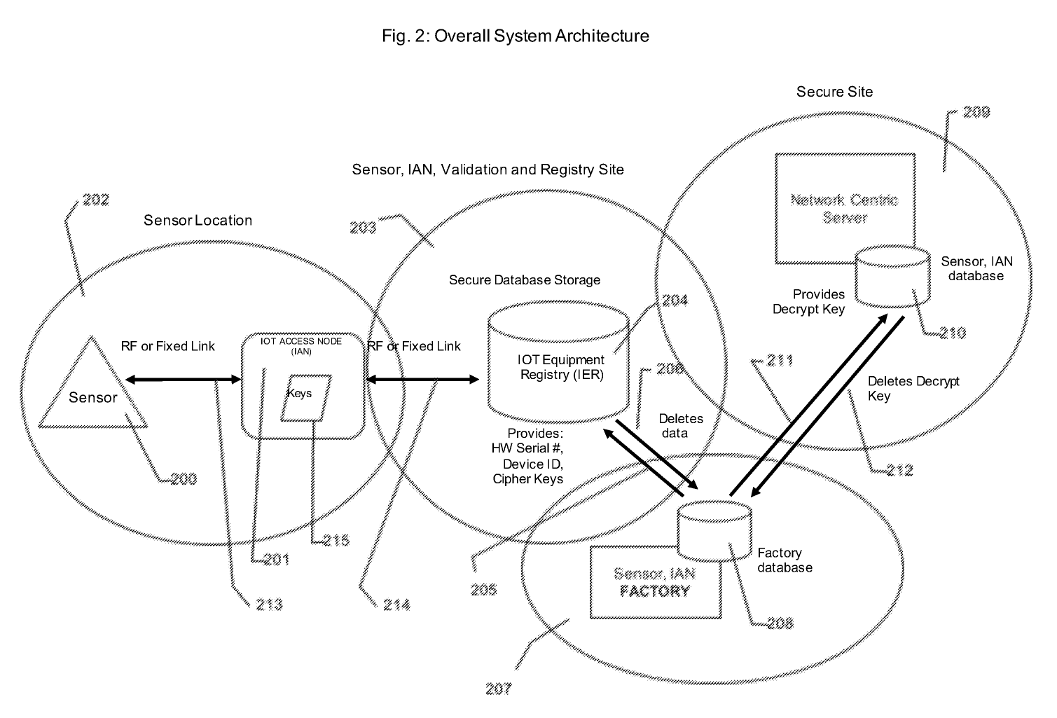

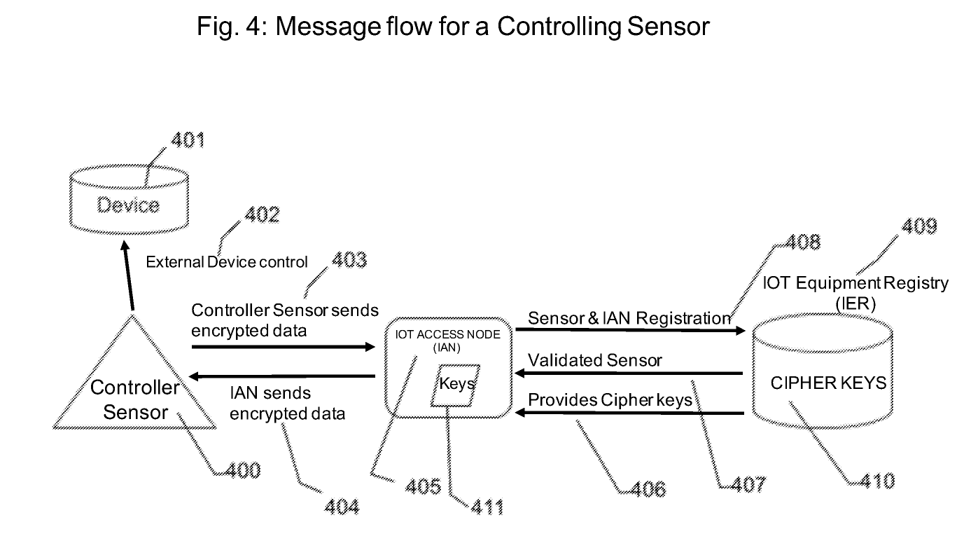

The Overall System Architecture (FIG. 2) considers implementation of two types of sensors/devices 200: the reporter and the controller. The reporter normally transmits information to the network and typically does not receive data from the network although it is possible that it may receive data in other embodiments of this invention. In one possible embodiment of the controller it receives command data/information from the Secure Database Storage 203, and/or the Secure Database Storage 209 and acts upon the received command data to perform local functions (e.g. turn on an alarm buzzer). In addition the controller sensor/device can also report command data or information (FIG. 4) 403 to the IOT Access Node (IAN) 405. Both types of sensor/device transmit at intervals determined during the manufacturing process. The transmissions can typically be time based, application/data based or condition threshold based. Other transmissions schemes are possible and can be envisioned in other applications.

In one embodiment of this invention it is assumed that the sensor/devices typically transmit small data packets for example 16 bytes (128 bits) at very infrequent intervals. In another embodiment of this invention there are no restrictions on the size of the data packet and other sizes could be easily implemented. As the total energy available to the sensor/device is typically limited the intent of this security scheme is to reduce the energy used in order to maximize the life of the sensor/device power source while protecting the sensitive network data. The power source might be for example a primary cell, rechargeable battery or an energy-harvesting device including but not limited to solar cells, piezo motion generators, atomic battery or fuel cell.

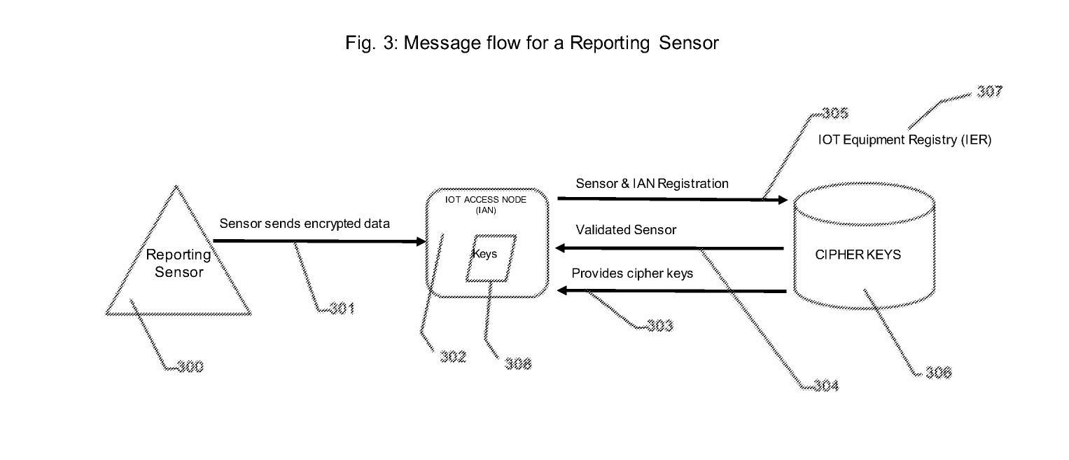

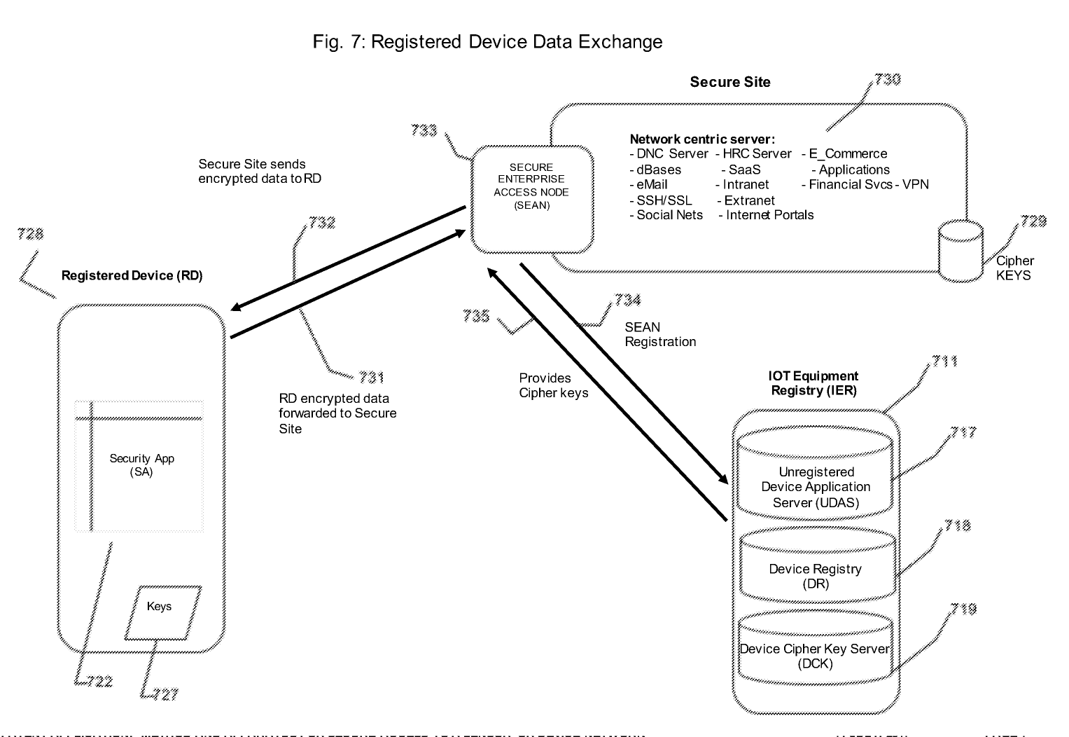

In one embodiment of the invention there are two main parts to the security framework (FIG. 2, FIG. 3, and FIG. 7): one part of this framework in one possible embodiment of this invention is the Access Node (AN) and the IOT Equipment Registry (IER) 204, 307. One instantiation of the Access Node (AN) is the IOT Access Node (IAN) 201, 302, 405, 505. Another instantiation of the Access Node (AN) is the Secure Enterprise Access Node (SEAN) 733. Other instantiations of the Access Node may be Cloud Access Node (CAN), Virtual Access Node (VAN), Digital Access Node (DAN), Mobile Access Node (MAN), Energy Access Node (EAN), Foreign Access Node (FAN), Home Access Node (HAN), Personal Access Node (PAN), or Radio Access Node (RAN). It is clear that one skilled in the art could easily extend this to other security applications without restriction. The Access Node (AN) typically:

encrypts and decrypts data transactions from and to sensors and devices 200, 302, 620, 728, and UD 620 or RD 728;

encrypts and decrypts data transaction with the IOT Equipment Registry (IER) 204, 511, 611 and 711;

validates secure access to and from sensors and devices 200, 302, 620, 728 and UD 620 or RD 728;

validates secure access to the IOT Equipment Registry (IER) 204, 511, 611 and 711.

In one embodiment of the invention there are two main parts to the security framework (FIG. 2 and FIG. 3): one part of this framework in one possible embodiment of this invention is the IOT Access Node (IAN) 201, 302, 405, 505 and IOT Equipment Registry (IER) 204 and 307. The IOT Access Node (IAN) 201 supports the radio link (or fixed wire link) 213 and 214 to the sensor/device 200 and 302. In addition the IOT Access Node typically:

encrypts and decrypts data transactions from and to the sensor/device 200, 302 and UD 620 or RD 728;

encrypts and decrypts data transaction with the IOT Equipment Registry (IER) 204 and 511;

validates secure access to and from the sensors/devices 200, 302 and UD 620 or RD 728;

validates secure access to the IOT Equipment Registry (IER) 204 and 511.

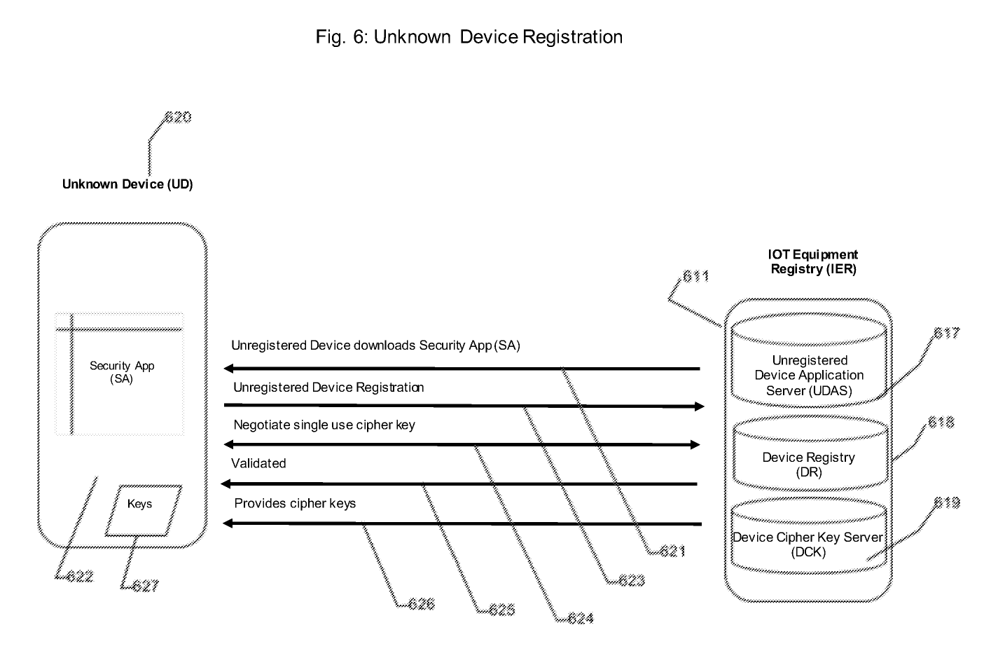

In another embodiment of the invention there are two main parts to the security framework (FIG. 6, FIG. 7): one part of this framework in one possible embodiment of this invention is the Secure Enterprise Access Node (SEAN) 733 and IOT Equipment Registry (IER) 611 and 711. The Secure Enterprise Access Node (SEAN) 733 supports the link 732 and 731 to the Registered Device (RD) 728. In addition the Secure Enterprise Access Node typically:

encrypts and decrypts data transactions from and to the device 731 and 732;

validates secure access to and from the Registered Devices 728;

In one embodiment of this invention a second part of this framework is the IOT Equipment Registry (IER) 204 and 511 which may store cipher keys 215, 306, 308, 410, 411, 512, 516, 619, 627, 719 and 727 that are generated during the manufacture or assembly (e.g. at Factory 207) of any or all of the devices associated with the network. The IOT Equipment Registry (IER) 204, 306, 410, 511, 611 and 711 provides a central repository for the security data associated with the sensor/device 200, 300, 400, 500, 620, 728, the IOT Access Node (IAN) 201, 302, 405 and 505, and Secure Enterprise Access Node (SEAN) 611 and 711 and Registered Devices (RD) 728.

In one embodiment of this invention a second part of this framework is the IOT Equipment Registry (IER) 204 and 511 which may locally generate and store cipher keys 215, 306, 308, 410, 411, 512, 516, 619, 627, 719 and 727 of any or all of the devices associated with the network.

In one embodiment of this invention a second part of this framework is the Unknown Device App Server (UDAS) 617 and 717 associated with the IOT Equipment Registry (IER) 204 and 511 which may upload a Security Application (SA) 622 and 722 software application to any or all of the devices associated with the network. The Unknown Device App Server (UDAS) 617 and 717 provides unknown devices a Security Application (SA) 622 and 722 a trusted means to register with the IOT Equipment Registry (IER) 204 and 511 and obtain unique cipher keys 215, 306, 308, 410, 411, 512, 516, 619, 627, 719 and 727.

In one embodiment of this invention network centric servers 513 and 730 may also be available in the sensor/device network. This network server provides similar or additional services to the IOT Access Node (IAN) 201, 302, 405 and 505 and Registered Devices (RD) 728. The Network Centric Server 513 allows a network operator to offer security services such as cipher KEYS 514 without the need for an IOT Access Node (IAN) 201 and 302, for example at locations that might be remote or otherwise difficult access.

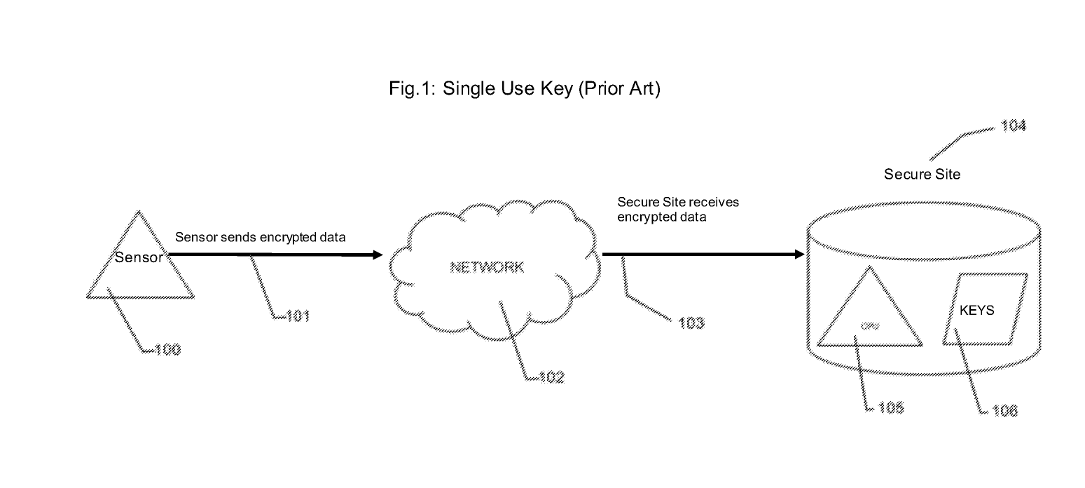

In one embodiment of this invention the security scheme is based on the well-documented intrinsic protection provided by a single use cipher key (FIG. 1) 106. A single use cipher key is only used to encrypt/decrypt one transmission 101 and 103 and never re-used. However there are certain inherent problems in using such a scheme in a sensor/device network:

It is impossible to pre-load a device with a lifetime's supply of cipher keys. This would be impractical primarily due the memory limitations of such low functionality sensors/devices 100 and the possible security risk should the stored cipher key table be compromised at some future date rendering the network insecure.

The lifetime of such sensors/devices 100 might be measured in multiple years, in some cases up to 20 years.

Both sides of the link 100 and 104 need to access the contents of the stored cipher key table 106 and be able to use that table as required to encrypt and decrypt messages.

Both sides need to be updated with new stored cipher keys 106 as they are consumed in the communications process.

In one embodiment of the invention it is assumed that the sensor/device 200, 300, 400 and 500 and/or Registered Devices (RD) 728 does have the ability to store a certain limited number of cipher keys internally and alter any bit position within the key table when commanded to do so by a controlling external device 201, 204 and 210 e.g. IOT Equipment Registry (IER) or IOT Access Node (IAN). Most modern embedded microcontrollers have internal flash memory that can be rewritten a limited number of times. They may also have unique serial numbers permanently written into their memory during the fabrication process.

In one embodiment of the invention during assembly of the sensor/device 200, 300, 400 and 500 or Registered Devices (RD) 728 the Factory 207 may securely place up to n×32 or 64 or 128 bit unique cipher keys into the processors flash memory along with an unique secure serialized identity, for example a serial number as used in the Atmel™ series of embedded devices. In addition the sensor/device 200, 300, 400 and 500 or Registered Devices (RD) 728 may have a visible unique serialized identity that a user can use to associate the device with an IOT Access Node (IAN) 201, 302, 405 and 505. The Factory can securely deliver the cipher keys, serialized number and other sensor/device or Registered Devices (RD) 728 data to the IOT Equipment Registry (IER) 204, 306, 410 and 511 database. The data may then be stored securely in the IOT Equipment Registry (IER) 204, 306, 410 and 511 indexed with the secure identity, visible unique serialized identity and cipher key table. The IOT Equipment Registry (IER) 204, 306, 410 and 511 may also register the identity of the IOT Access Node (IAN) 201, 302, 405 and 505 associated with a particular sensor/device to prevent the sensor/device 200, 300, 400 and 500 or Registered Devices (RD) 728 being taken over by other 3^{rd} parties. The number of cipher keys used is by way of an illustrative example and other derivative schemes could be considered while still adhering to the same method in future alternative embodiments of this invention.

In one embodiment of this invention the IOT Access Node (IAN) 201, 302, 405 and 505 typically has a similar unique secure serialized number, unique visible serialized identity and several internal cipher keys, however the ability for the IOT Access Node (IAN) 201, 302, 405 and 505 to communicate on a potentially broadband network means that alternative methods could be used to authenticate the IOT Access Node (IAN) 201, 302, 405 and 505 and its permission to access the network. Before an IOT Access Node (IAN) 201, 302, 405, 505 can communicate with the network it needs to be authenticated with the IOT Equipment Registry (IER) 204, 306, 410 and 511 as a genuine IOT Access Node (IAN) 201and 302 and similarly the IOT Access Node (IAN) 201, 302, 405 and 505 needs to authenticate the IOT Equipment Registry (IER) 204, 306, 410 and 511 to determine if it is genuine. The method outlined below for the sensor/device 200, 300, 400 and 500 could also be used with the IOT Access Node (IAN) 201, 302, 405 and 505 in this embodiment of the invention.

In one embodiment of this invention the secure internal serialized number and user visible serialized number 205 should not normally be related in any way nor should they be the same. Similarly the encryption (Cipher) keys 205 and 512 should not typically bear any resemblance to or be derived from either of the serialized numbers. The cipher keys 205 and 514 generated from the Factory 207 during manufacture should preferably be created using a random number generator that employs environmental noise [9] (e.g. from unstable electronic components) rather than shift registers or other deterministic means. This will help prevent sequences of cipher keys 205 and 512 that might be compromised should one cipher key 205 and 512 be uncovered.

In one embodiment of this invention an alternative to the serialized number could be to use a hash algorithm (e.g. MD5) computed across the data stored in the internal flash memory. If a 3^{rd} party user changes the internal processor code in any way to attack the sensor/device and/or Registered Devices (RD) 728 then the MD5 hash would be different, therefore the device check would then fail when sent to the network. The MD5 hash could also incorporate the stored encryption cipher keys, which are unique on each device, making the MD5 hash different for each device and similar to a digital fingerprint.

Securing the IOT Access Node (IAN) and Secure Enterprise Access Node (SEAN)

In one embodiment of the invention when the IOT Access Node (IAN) 201, 302, 405 and 505 or Secure Enterprise Access Node (SEAN) 733 first accesses the network the onboard security processor should provide the IOT Access Node (IAN) 201, 302, 405 and 505 main processor or Secure Enterprise Access Node (SEAN) 733 with a registration message packet pre-encrypted. This packet should be encrypted with a randomly selected cipher key from the cipher keys stored in the IOT Access Node (IAN)'s 201, 302, 405 and 505 or Secure Enterprise Access Node (SEAN) 733 security processor. The packet may typically contain one or more of the following: a timestamp, random number, CRC, a packet count, secure serialized identity/MD5 hash of the flash memory contents etc. The packet is forwarded to the IOT Equipment Registry (IER) 204, 306, 410, 511, 611 and 711 with the IOT Access Node (IAN) 201, 302, 405 and 505 or Secure Enterprise Access Node (SEAN) 733 unique visible serialized identity added to the data packet in clear text 508. The IOT Equipment Registry (IER) 204, 306, 410, 511, 611 and 711 will attempt to decode the IOT Access Node (IAN) 201, 302, 405 and 505 or Secure Enterprise Access Node (SEAN) 733 registration packet with all the cipher keys 512 and 719 available for the identified IOT Access Node (IAN) 201, 302, 405 and 505 or Secure Enterprise Access Node (SEAN) 733. If the decryption succeeds then the IOT Equipment Registry (IER) 204, 511, 611 and 711 will check the contents are valid, if so then the packet has been successfully deciphered. A successfully deciphered message will indicate the IOT Access Node (IAN) 201, 302, 405 and 505 or Secure Enterprise Access Node (SEAN) 733 is genuine. The IOT Equipment Registry (IER) 204, 511, 611 and 711 will then send an acknowledgement response with a cipher key 205, 512 and 719 from the set that is typically a fixed/known offset from the cipher key used to encrypt the register message 506, 735. The register acknowledgement packet may contain for example a time stamp, random number, packet count, CRC, or commands to activate the radio of the IOT Access Node (IAN) 201, 302, 405, and 505.

In one embodiment of this invention if upon receipt of the register acknowledgement it is successfully deciphered using the offset cipher key stored during manufacture then the IOT Access Node (IAN) 201, 302, 405 and 505 or Secure Enterprise Access Node (SEAN) 733 security processor will enable the radio access.

In one embodiment of this invention the random number in the register message and register acknowledgement message may be used to modify the cipher key 512 and 719 used in the respective registration transactions. However the modification will typically not happen at the IOT Equipment Registry (IER) 204, 306, 410, 511, 611, and 711 until it receives another valid transmission from the IOT Access Node (IAN) 201, 302, 405 and 505 or Secure Enterprise Access Node (SEAN) 733 during the ongoing updating process. Using this method of changing the stored cipher key 512 and 719 reduces the burden on the network link as well as the energy required to transmit the data to the IOT Equipment Registry (IER) 204, 306, 410, 511, 611 and 711. The IOT Access Node (IAN) 201, 302, 405 and 505 or Secure Enterprise Access Node (SEAN) 733 may also be using limited power resources e.g. solar power.

First Network Access by Sensor/Device

In one embodiment of the invention when a sensor/device 200, 300 and 400 powers up for the very first time whether it is a reporting or controller type of sensor/device 200, 300 and 400 it will typically access the network in the same manner. The sensor/device 200, 300 and 400 will encrypt and send a registration packet 301, 403 and 503 with (for example) the n-1th cipher key from the internal cipher key table to the IOT Access Node (IAN). The encrypted data may include the secure serialized number/MD5 hash of flash, a random number, cipher key offset, CRC digits and any other pertinent information. The encrypted packet may include the clear text user visible serialized identity. As this is the first time the IOT Access Node (IAN) 201, 302, 405 and 505 has seen the sensor/device based on the visible identity it will immediately forward the received packet on to the IOT Equipment Registry (IER) server 204, 306, 410 and 511. It is assumed that the IOT Access Node (IAN) 201, 302, 405 and 505 has been validated with the IOT Equipment Registry (IER) 204, 306, 410 and 511 prior to the sensor/device 200, 300, 400 and 500 remote access (see previous section). It is further assumed that the IOT Access Node (IAN) has a registration entry for the user visible identity. If no such registration exists the packet will be dropped and not forwarded, as any registration will fail. The IOT Access Node (IAN) 201, 301, 405 and 505 will temporarily log the receipt of the user visible identity of the sensor/device 200, 300, 400 and 500 in an internal secure table e.g. internal to the onboard security processor. The IOT Access Node (IAN) 201, 301, 405 and 505 may also encrypt the received registration packet with its own cipher keys 215, 308, 411 and 516 or use some other enciphering technique. In this case the IOT Equipment Registry (IER) 204, 306, 410 and 511 and IOT Access Node (IAN) 201, 301, 405 and 505 would store the public keys of each entity. Other possible embodiments of this process are possible while adhering to the original intent.

In one embodiment of the invention the IOT Equipment Registry (IER) 204, 306, 410 and 511 upon receiving the registration packet from the sensor/device 200, 300, 400 and 500 will use the n-1th stored cipher key to decipher the packet. If the decryption fails then the failure can be logged and the IOT Access Node (IAN) 200, 300, 400 and 500 commanded to forget the data. If the decoding is successful the CRC will then be checked to confirm the packet integrity, subsequently the secure serialized number/MD5 hash will then be checked. If these pass then the device will be considered genuine. As an additional safeguard the internal message could also be encrypted with another shared cipher key. The IOT Equipment Registry (IER) 204, 306, 410 and 511 will now securely provide the n-cipher keys generated during manufacture of the sensor/device to the IOT Access Node (IAN) security processor 506 to be used when communicating with the sensor/device. The IOT Access Node (IAN) 201, 301, 405 and 505 will store all the cipher keys in a secure manner.

In one embodiment of the invention, if the sensor/device 200, 300, 400 and 500 has receiving capabilities the IOT Equipment Registry (IER) 204, 306, 410 and 511 may then send a registration acknowledgement packet to the sensor/device 200, 300, 400 and 500 that typically includes its secure serialized number, the random number provided, CRC field and a cipher key change request with, for example 16 bits of new cipher key data and an offset 507. The data will typically be encrypted with the nth cipher key. Upon successful receipt of the packet the sensor/device 200, 300, 400 and 500 will decipher the packet. If successful it will now assume it is allowed to use the network. It may replace the location indicated in the nth cipher key with the provided 16 bit cipher key update and also update the n-1th cipher key with the random number it provided originally. The IOT Equipment Registry (IER) 204, 306, 410 and 511 will perform the same actions to its cipher keys. Both the nth and n-1th cipher keys will have been updated with new data. The indicated offsets can be random in nature. Other possible implementations are possible to perform the cipher key updates.

There are several failure conditions in the registration access that need to be addressed.

In one embodiment of this invention if the IOT Equipment Registry (IER) 204, 306, 410 and 511 for some reason does not respond within the regular update interval of the sensor/device the unit may try again with a new set of data in the packet, but using the same n-1th cipher key.

In one embodiment of this invention if the IOT Equipment Registry (IER) 204, 306, 410 and 511 responds with a registration packet then it will in one embodiment of the invention retain the old and new cipher keys until the new registration is acknowledged by some means, for example by the first non-registration encrypted packet sent to the IOT Access Node (IAN) by the sensor/device—this will indicate that the device received the acknowledgement from the IOT Equipment Registry (IER) (see below).

In one embodiment of this invention if the IOT Equipment Registry (IER) 204, 306, 410 and 511 receives a new registration packet prior to any acknowledgement it will assume the previous registration has failed and delete the new cipher key and reuse the old cipher key.

In one embodiment of this invention the next access by the sensor/device 200, 300, 400, and 500 could use a different cipher key from the stored cipher key set. In this case the process uses fresh cipher keys on each access.

In one embodiment of this invention if the registration process is successful and the sensor/device receives the register acknowledgement with cipher key updates then it can begin communication with the network. The first sensor/device data sent to the network will contain the acknowledgement to the IOT Equipment Registry (IER) 204, 306, 410 and 511 added into the data. Once the acknowledgement has been received the IOT Equipment Registry (IER) 204, 306, 410 and 511 will update the n-1th and nth cipher keys. The IOT Access Node (IAN) 201, 301, 405 and 505 security processor will forward the registration acknowledgement to the IOT Equipment Registry (IER) 204, 306, 410 and 511.

It should be noted that in order to determine the cipher key by eavesdropping typically more than one packet of data using the same cipher key is required. In this scheme packets are typically transmitted with different cipher keys even if the cipher keys is repeated it would be a significant amount of time before sufficient encrypted packets were available with the same cipher key. Furthermore since the cipher key could be chosen randomly each time it will be very difficult to correlate the packets using the same cipher key. In addition if the cipher keys are updated for a controlling device 400, then the cipher keys will change over the course of time so there would never be any correlation with previous data.

First Network Access by Unknown Device (UD) 620

In one embodiment of the invention any Unknown Device (UD) 620 first contacts the Unregistered Device Application server—UD App Server (UDAS) 617, 717 on the IER 611 to download a Security App 621, 622 and 722. The device 620 will then attempt to register 623 with the IER 611 by sending an encrypted registration packet. The packet is encrypted with a “one-time use” shared key generated by using, for example, the Diffie-Hellman key exchange procedure as part of the registration steps. The encrypted registration packet may include, for example, the secure serialized number/MD5 hash of flash, a random number, CRC digits and any other pertinent unique information. The encrypted registration packet may include the clear text user visible serialized identity of the Unknown Device. The IER will use the previously generated shared key to decrypt the registration packet and will respond, if the decrypt is successful, with an encrypted packet (or packets) containing pre-generated cipher keys for use by the unknown device. The same key will be used to decrypt the packet(s) sent to the UD 620. When the final step is completed the device will be considered a secure Registered Device 728. Also once this step is completed any attempts to reuse the generated shared key will be ignored and flagged as a security breach.

In other embodiments of this invention the IAN or SEAN may also be considered to be Unknown Devices (UD) 620 on the network and could perform registration in a similar fashion. The description provided here should not restrict the scope of the application of this invention.

Upon successful registration by the unknown device 620 (as outlined above) with the IER 204, 306, 410, 511, 611 and 711, the IER will provide cipher keys 735 to the associated SEAN 733. It is assumed that the SEAN 733 has been validated with the IER 204, 306, 410, 511, 611 and 711 prior to the unknown device 620 remote access (see previous section). Other possible embodiments of this process are possible while adhering to the original intent.

Sensor/Device and Registered Device (RD) 728 Communication with Network.

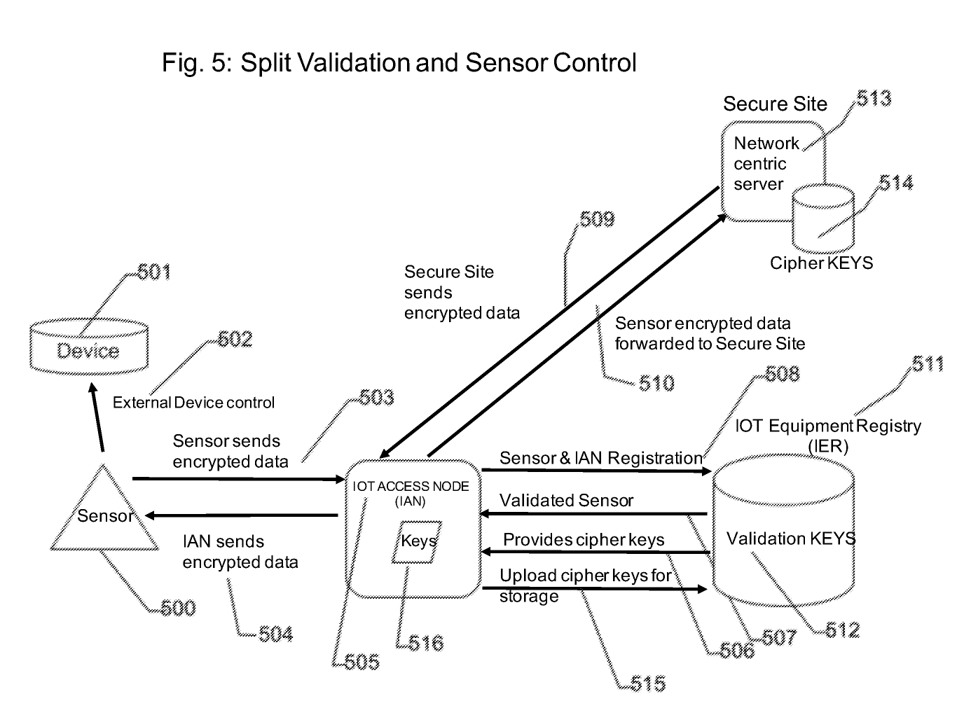

In one embodiment of this invention when a sensor/device 200, 300, 400, 500 or Registered Device 728 has something to send to the network it will typically randomly pick one of the cipher keys stored and encrypt the data to be sent (FIG. 3) 301 (FIG. 4) 403, (FIG. 5) 503 and (FIG. 7) 732. In addition to the data to be sent a random number, cipher key offset, CRC digits may also be included as well as an acknowledgement to any other messages sent to the sensor/device 200, 300, 400 and 500 (see below). Upon receipt of the data packet from the sensor/device 200, 300, 400 and 500 or Registered Device 728, the IOT Access Node (IAN) 201, 301, 405 and 505 or Secure Enterprise Access Node (SEAN) 733 security processor will use the cipher key set 303, 406, 506, 626 and 735 provided by the IOT Equipment Registry (IER) 204, 306, 410, 511, 611 and 711 during registration to attempt to decipher the message. Once deciphered the clear text will be checked for validity and if valid passed to the IOT Access Node (IAN) 201, 301, 405 and 505 or Secure Enterprise Access Node (SEAN) 733 processor as clear text for further processing. If the decipher fails due to non RF related issues the failure will be logged and may be sent to the IOT Equipment Registry (IER) 204, 306, 410 and 511 or stored in the Secure Enterprise Access Node (SEAN) 733 for further logging 305, 408, 508 and 623.

In one embodiment of this invention if the sensor/device 200, 300, 400 and 500 or Registered Device 728 is able to receive messages the IOT Access Node (IAN) 201, 301, 405 and 505 or Secure Enterprise Access Node (SEAN) 733 might immediately prepare an acknowledgement message that includes a cipher key update for the cipher key used to send the message and the cipher key being used to the send the acknowledgement. The cipher key used to send the acknowledgement will typically be a known offset from the cipher key used to initially encrypt the message sent to the IOT Access Node (IAN) 201, 301, 405 and 505 or the Secure Enterprise Access Node (SEAN) 733. The sensor/device 200, 300, 400 and 500 or Registered Device 728 will initiate any pending updates of the cipher keys after receiving the acknowledgement. The IOT Access Node (IAN) 201, 301, 405 and 505 or Secure Enterprise Access Node (SEAN) 733 security processor will update its cipher keys 215, 308, 411, 516 and 729 when the next acknowledgement is received, until then the two cipher keys will remain valid. Once the successful acknowledgement is received the cipher keys 215, 308, 411, 516 and 729 will be updated. In extreme cases the IOT Access Node (IAN) 201, 301, 405 and 505 or Secure Enterprise Access Node (SEAN) 733 security processor might have to use the two pending cipher keys to attempt a message decode in case the previous acknowledgement failed. In which case the IOT Access Node (IAN) 201, 301, 405 and 505 or Secure Enterprise Access Node (SEAN) 733 security processor or sensor/device 200, 300, 400 and 500 or Registered Device 728 will be aware that an acknowledgement was missed and can act accordingly.

In one embodiment of this invention the sensor/device 200, 300, 400, 500 or Registered Device 728 may communicate with the IOT Access Node (IAN) 201, 301, 405 and 505 or Secure Enterprise Access Node (SEAN) 733 on Virtual Private Networks (VPN) through use of Secure Shell (SSH), Internet Protocol Security (IPSec), or other secure network systems which rely on exchanging keys. Other schemes that rely on pre-shared or generated shared keys can make use of this method. It is clear that one skilled in the art could extend this method to other security applications without restriction.

In one embodiment of this invention once a transaction between the sensor/device 200, 300, 400 and 500 or Registered Device 728 and IOT Access Node (IAN) 201, 301, 405 and 505 security processor has successfully concluded the cipher key data will have been changed. Over time all the cipher keys in the IOT Access Node (IAN) 201, 301, 405 and 505, Registered Device 728 and sensor/device 200, 300, 400 and 500 will be changed. At some point the IOT Access Node (IAN) 201, 301, 405 and 505 security processor might upload the new cipher keys 515 to the IOT Equipment Registry (IER) 204, 306, 410 and 511 for storage (see below shared IOT Access Nodes (IANs)) and backup purposes, for example if an IOT Access Node (IAN) failed then the cipher keys for a sensor/device might be lost rendering it useless. With the backup the IOT Equipment Registry (IER) can send the cipher keys to the new/replacement IOT Access Node (IAN) that will be supporting the sensor/device.

Options for Cipher Key Rotations

In the above example embodiments it has been assumed that the cipher keys are separate individual entities, each one being used atomically on the encryption of the data sent to the network. The cipher keys are modified using the random numbers sent in the packets between the IOT Access Node (IAN) <-> IOT Equipment Registry (IER) and sensor/device <-> IOT Access Node (IAN). There are a few possible scenarios that might be considered, depending on the level of complexity required in the sensor/device 201, 301, 405, 505 or Registered Device 728 and the flash memory available for storing the cipher key data.

In one embodiment of this invention the cipher keys could be stored as one long digit string in the flash memory of the device. The cipher key to be used is then selected as a 32/64/128-bit section in the stored digit string. For example a random sequence of digits 4096 bits long could be stored in flash memory. To encrypt the data the device would randomly select one of the sections (32-bits or 64-bits or 128-bits) of the stored digit string to use as the cipher key. The randomly selected position could be indicated as a clear-text offset in the data packet, for example as part of the clear text visible identity. The stored cipher key would then be modified at this offset from that starting position. The cipher key selection/modification would wrap round modulo 2ⁿ-1 if the cipher key offset selected would exceed the remaining number of digits in the random string.

In one embodiment of this invention a smaller cipher key string could be used and the Registered Device 728 or sensor/device 200, 300, 400 and 500 selects a random position that is not communicated to the network. The network device then uses the whole string to attempt the decryption. If the decryption was performed in hardware then multiple decryption engines could be used simultaneously on the string to produce the clear text. This way an eavesdropper would be unaware of the position used.

In one embodiment of this invention the cipher key could be read from the program memory of the Registered Device 728 and use the program data itself as the cipher key for data encryption. The object code bytes programmed into the device would be known during manufacturing. Any attempt to change the code or modify it would result in the cipher key sequence no longer matching the data stored in the network and consequently any deciphering attempt would fail, rendering the device useless to the 3^{rd} party.

Other schemes could be devised based upon the ideas presented above for the rotation and modification of the cipher key. The pervious examples are illustrative only and should not restrict the invention in any way.

Registered Device 728 or Sensor/Device Secure Communications with Secure Site Systems

In one embodiment of this invention in order to provide added security it may be desirable that deciphering of data is only performed at a remote Secure Site operation 209 and 513 and fully secured from decryption either locally at the Registered Device 728 location, sensor/device location, or by the site IOT Access Node (IAN) 505. If this is required then in one embodiment of this invention it is very easy for the IOT Access Node (IAN) 201, 301, 405 and 505 to forward the Registered Device 728 or sensor/device 201, 301, 405 and 505 encrypted data onto the Secure Site 209 and 513 by simply acting as a forwarder 510. The Registered Device 728 or sensor/device 201, 301, 405 and 505 data can now only be deciphered by the Secure Site 513 and 209. Further security will be provided by the fact that the IOT Access Node (IAN) 201, 301, 405 and 505 will not have the cipher keys required to decipher any of the sensor/device data.

Registered Device 728 or Sensor/Device using Multiple IOT Access Node (IAN)s

The nature of radio communications means that a Registered Device 728 or sensor/device 200, 300, 400 and 500 registered on one IOT Access Node (IAN) might be able to communicate more reliably with another IOT Access Node (IAN) 201, 301, 405, and 505. Therefore post Registered Device 728 or sensor/device registration there may be an option that allows the IOT Access Node (IAN) 201, 301, 405 and 505 to forward packets from unrecognized sensors/device onto the network IOT Equipment Registry (IER) or other network entity so they can be sent to their final destination IOT Access Node (IAN) 201, 301, 405 and 505. The receiving IOT Access Node (IAN) 201, 301, 405 and 505 should then recognize the packet and be able to decipher the packet and perform the required actions.

Registered Device 728 using Multiple Secure Enterprise Access Node (SEAN)s

The nature of communications means that a Registered Device 728 registered on one SEAN 733 might be required to communicate with other SEAN 733 such as in the case of Extranets, Intranets, or by Service Providers. Therefore post device registration there may be an option that allows the SEAN 733 to forward packets from unrecognized devices onto the network IER or other network entity so they can be sent to their final destination SEAN 733. The receiving SEAN 733 should then recognize the packet and be able to decipher the packet and perform the required actions.

Network Logging by IOT Equipment Registry (IER)

Sensor/device networks are under frequent attack by 3rd parties and are therefore vulnerable to security breaches. Currently they lack the capability to monitor and log valid and invalid transactions. While the IOT Access Node (IAN) 201, 301, 405 and 505, Secure Enterprise Access Node (SEAN) 733 and the IOT Equipment Registry (IER) 204, 306, 410, 511, 611 and 711 will allow secure network transactions 3^{rd} parties will continue to attack these networks due to the perceived limitations of the Registered Device 728 or sensor/device 201, 301, 405, 505 and 728.

In one embodiment of this invention the IOT Access Node (IAN) 201, 301, 405 and 505, Secure Enterprise Access Node (SEAN) 733 and the IOT Equipment Registry (IER) 204, 306, 410, 511, 611 and 711 can also in combination ensure all successful and unsuccessful network transactions are stored at the IOT Equipment Registry (IER) 204, 306, 410, 511, 611 and 711 location for later analysis to help resolve manufacturer equipment malfunctions, analyze network problems, and identify rogue devices or hackers.

In one embodiment of this invention the IOT Access Node (IAN) 201, 301, 405 and 505, Secure Enterprise Access Node (SEAN) 733 and the IOT Equipment Registry (IER) 204, 306, 410, 511, 611 and 711 can also in combination ensure all successful and unsuccessful network management transactions are stored at the IOT Equipment Registry (IER) 204, 306, 410, 511, 611 and 711 location for later analysis to help determine network management security exposures.

In one embodiment of this invention, every transaction secured by the IOT Access Node (IAN) 201, 301, 405 and, 505, Secure Enterprise Access Node (SEAN) 733 and the IOT Equipment Registry (IER) 204, 306, 410 and 511 may be easily traceable. One embodiment of this invention ensures that any sensor/device 201, 301, 405 and 505, Registered Device 728, IOT Access Node (IAN) 201, 301, 405 and 505, or Secure Enterprise Access Node (SEAN) 733 will typically first register with the IOT Equipment Registry (IER) 204, 306, 410, 511, 611 and 711 and are in turn provided unique and identifiable security cipher keys which are randomly updated by an IOT Equipment Registry (IER) 204, 306, 410, 511, 611 and 711, an IOT Access Node (IAN) 201, 301, 405 and 505 or Secure Enterprise Access Node (SEAN) 733 over time. As all devices must typically first be validated by the IOT Equipment Registry (IER) 204, 306, 410, 511, 611 and 711 prior to any transaction, their identities and transactions can be captured in a log on the IOT Equipment Registry (IER) 204, 306, 410, 511, 611 and 711 site for later processing. This IOT Equipment Registry (IER) 204, 306, 410, 511, 611, and 711 logging function may provide a history of transactions, login attempts, location of activity and precise activity, etc. which might be useful for auditing sensor/device 201, 301, 405 and 505 or Registered Device 728 behavior.

Although the description has been described with respect to particular embodiments thereof, these particular embodiments are merely illustrative, and not restrictive.

Particular embodiments may be implemented by using a programmed general purpose digital computer, by using application specific integrated circuits(ASIC), programmable logic devices (PLD), field programmable gate arrays (FPGA), optical, chemical, biological, quantum or nano-engineered systems, components, and mechanisms. In general, the functions of particular embodiments can be achieved by any means as is known in the art. Distributed, networked systems, components, and/or circuits can be used. Communication or transfer of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application.

As used in the description herein and throughout, the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. An apparatus comprising:
a. a sensor/device network system for communication with at least one sensor/device;
b. at least one network equipment register used to store encryption keys for the sensor/device;
c. at least one Access Node (AN) used to allow the sensor/device access to the network;
d. at least one Unregistered Device Application Server; and
e. at least one sensor/device;
f. at least one Unregistered Device; and
g. at least one Registered Device.

2. The communication system of claim 1 wherein the IOT Equipment Registry (IER) is configured to decipher messages from the Registered Device.

3. The communication system of claim 1 wherein the IOT Equipment Registry (IER) is configured to authenticate messages from the Registered Device.

4. The communication system of claim 1 wherein the Unregistered Device Application Server is the source of a download of a Security Application to the Unregistered Device.

5. The block cipher in claim 2 uses the Simon and Speck standard algorithm.

6. The communication system of claim 1 wherein the IOT Equipment Registry (IER) is configured to decipher messages from an Unregistered Device.

7. The communication system of claim 1 wherein the IOT Equipment Registry (IER) is configured to authenticate messages from an Unregistered Device.

8. A method comprising:
a. an IOT Equipment Registry (IER) containing a means of dynamically generating a set of shared encryption keys; and
b. an Unregistered Device Application server that can provide a security application to the Unregistered Device; and
c. an Unregistered Device.

9. The method in claim 8 further comprising the ability of the Unregistered Device to generate a registration packet using key exchange techniques.

10. The method in claim 8 further comprising the ability of the Unregistered Device to contact the IER to register on the network.

11. The method in claim 8 further comprising the ability of the network to select the shared key generation algorithm.

12. The method in claim 11 further where the algorithm uses the Diffie-Hellman key exchange procedure.

13. The method in claim 8 further comprising the ability of Unregistered Device to register on the network by:
a. the Unregistered Device sending a registration message encrypted with a single use shared key from a key generation algorithm; and
b. the IER unit recognizing the message as a registration message from the Unregistered Device message; and
c. the IOT Equipment Registry (IER) decrypting the message with said one time generated shared key; and
d. confirming the correct cipher key was used to encrypt said message; and
e. the IOT Equipment Registry (IER) forwarding a set of cipher keys to the Unregistered Device to store for use when ciphering data to/from the sensor device network.

14. The IOT Equipment Registry (IER) in claim 13 wherein it can send a registration acknowledgement to the Unregistered Device.
